(19) United States
(12) Patent Application Publication
(10) Pub. No.: US 2008/0084378 A1
(43) Pub. Date: Apr. 10, 2008

(54) DISPLAY DEVICE AND METHOD FOR DRIVING THE SAME

(76) Inventors: Jae Han Lee, Taean-Gun (KR); Sun Kyu Son, Suwon (KR); Myong Bin Lim, Seoul (KR); In Yong Hwang, Suwon (KR); Ock Jin Kim, Cheonan-Si (KR)

Correspondence Address: MACPHERSON KWOK CHEN & HEID LLP, 2033 GATEWAY PLACE, SUITE 400, SAN JOSE, CA, 95110, US

(21) Appl. No.: 11/869,535

(22) Filed: Oct. 9, 2007

(30) Foreign Application Priority Data
Oct. 9, 2006 (KR) 10-2006-0097982

(51) Int. Cl. G09G 3/36

(52) U.S. Cl. 345/92

(57) ABSTRACT

A display device and a method for driving the same wherein the timing of the gate clock signal, which is an output of a timing controller, is changed to a time before a data latch signal is applied, so that degradation of the image due to gate noise can be prevented. That is, a gate turn-on voltage is applied before the data latch signal to turn on thin film transistors in an interval in which a gate turn-off voltage is stabilized. Accordingly, the generation of horizontal streaks in the lower portion of the display device is prevented.

### CROSS-REFERNCE TO RELATED PATENT APPLICATION

This application claims priority to Korean Patent Application No. 2006-0097982, filed on Oct. 9, 2006, in the Korean Intellectual Property Office, the disclosure of which is incorporated by reference herein.

### BACKGROUND OF THE INVENTION

1. Field of the Invention

The present invention relates to a display device and a method for driving the same, and more particularly, to a display device and a method for driving the same, wherein an unstable operation of a thin film transistor can be prevented by causing the time when a gate turn-on voltage is applied to be earlier than the time when a data signal is applied.

2. Discussion of the Background

A display device comprises a display panel for displaying images thereon and a control unit for controlling the display panel. A liquid crystal display (LCD), which is one of such display devices, comprises an LCD panel having thin film transistors (TFTs) and a pixel capacitor with liquid crystals interposed between common and pixel electrodes; and a control unit for controlling the LCD panel. The LCD panel comprises a plurality of gate lines and a plurality of data lines intersecting the gate lines.

In operation, the LCD, a gate turn-on voltage is applied to a gate line, and a data signal is applied to a data line. The gate line signal turns on the TFT and the data signal of the data line is charged into a pixel electrode. Accordingly, an electric field between both electrodes of the pixel capacitor is changed, resulting in changes in the arrangement of the liquid crystals.

However, since a plurality of gate and data lines intersects each other, a coupling phenomenon due to a parasitic capacitor occurs between the gate and data lines. The coupling phenomenon causes an abnormal rise in the gate turn-off voltage. Since the TFT is turned on during the interval when the gate turn-off voltage abnormally rises, gate noise (i.e., an unstable operation of the TFT) is generated. Such gate noise causes a problem of malfunction of an LCD, such as generation of horizontal streaks on a gate basis at a lower portion of a screen.

### SUMMARY OF THE INVENTION

In accordance with an aspect of the present invention a display device and a method for driving the same, wherein generation of gate noise can be prevented, comprises: applying a gate turn-on voltage before a data latch signal to turn on a thin film transistor prior to an interval in which a gate turn-off voltage abnormally rises.

An exemplary method of the present invention comprises turning on a plurality of first thin film transistors (TFTs) in accordance with a first clock signal; supplying a data signal at a first voltage level to first pixel capacitors through the turned-on first TFTs; turning on a plurality of second TFTs in accordance with a second clock signal; turning off the plurality of first TFTs and supplying a data signal at a second voltage level to second pixel capacitors through the turned-on second TFTs; and turning off the plurality of second TFTs.

The first and second TFTs may be turned on during logic high intervals of the first and second clock signals, and the first gate clock signal at logic high may be applied prior to a data latch signal.

When the first gate clock signal is changed from logic low to logic high, the second gate clock signal may be changed from logic high to logic low.

Logic high intervals of the first and second clock signals may overlap with each other.

An exemplary embodiment of the present invention, there is provided a display device comprising a timing controller for supplying first and second gate clock signals, a data signal and a data latch signal; a voltage generation unit for supplying a gate turn-on voltage and a gate turn-off voltage; a liquid crystal display (LCD) panel provided with first and second thin film transistors (TFTs) driven by a voltage applied to first and second gate lines so as to supply first and second pixel capacitors with the data signal applied to data lines; a gate driving unit for supplying the gate turn-on or turn-off voltage to the first and second gate lines in accordance with the first and second clock signals; and a data driving unit for supplying the data signal to the data lines in accordance with the data latch signal, wherein the gate turn-on voltage is applied to the first and second gate lines during logic high intervals of the first and second gate clock signals, and the first gate clock signal at logic high is applied prior to the data latch signal.

The first gate clock signal at logic high may be first applied, and the logic high intervals of the first and second gate clock signals may overlap with each other.

The LCD panel may have a substrate provided with the first and second TFTs, and the gate driving unit may be mounted on the substrate in the form of an IC chip connected to at least one side region of the first and second gate lines or manufactured on the substrate in the form of a plurality of stages connected to at least one side region of the first and second gate lines.

An exemplary embodiment of the present invention, there is provided a method for driving a display device, comprising the steps of turning on a plurality of thin film transistors (TFTs) in accordance with a gate clock signal of a timing controller; supplying a data signal to pixel capacitors through the plurality of turned-on TFTs in accordance with a data latch signal from the timing controller; and turning off the plurality of TFTs.

The TFTs may be turned on during a logic high interval of the gate clock signal, and the gate clock signal at logic high may be applied prior to the data latch signal.

An exemplary embodiment of the present invention, there is provided a display device comprising a timing controller for supplying a gate clock signal, a data signal and a data latch signal; a voltage generation unit for supplying a gate turn-on voltage and a gate turn-off voltage; a liquid crystal display panel provided with thin film transistors driven by a voltage applied to gate lines so as to supply the data signal from data lines to respective pixel capacitors; a gate driving unit for supplying the gate turn-on or turn-off voltage to the gate lines in accordance with the clock signal; and a data driving unit for supplying the data signal to the data lines in accordance with the data latch signal, wherein the gate turn-on voltage is applied to the gate lines during a logic high interval of the gate clock signal, and the gate clock signal at logic high is applied prior to the data latch signal.

The display device may further comprise a control signal generation unit provided between the timing controller and the gate driving unit to generate a clock signal or a reversed clock signal in accordance with the gate clock signal and to apply the generated signal to the gate driving unit.

### BRIEF DESCRIPTION OF THE DRAWINGS

The above and other objects, features and advantages of the present invention will become apparent from the following description of preferred exemplary embodiments given in conjunction with the accompanying drawings, in which:

FIG. 1 is a block diagram showing a display device according to a first exemplary embodiment of the present invention;

FIG. 2 is a block diagram showing a data driving unit in the first exemplary embodiment of the present invention;

FIG. 3 is a waveform diagram illustrating an operation of the display device according to the first exemplary embodiment of the present invention;

FIG. 4 is a block diagram showing a display device according to a second exemplary embodiment of the present invention;

FIGS. 5 and 6 are block diagrams of display devices according to variants of the second exemplary embodiment of the present invention;

FIG. 7 is a waveform diagram illustrating an operation of the display device according to the second exemplary embodiment of the present invention;

FIG. 8 is a block diagram showing a display device according to a third exemplary embodiment of the present invention; and

FIG. 9 is a waveform diagram illustrating an operation of the display device according to the third exemplary embodiment of the present invention.

### DETAILED DESCRIPTION

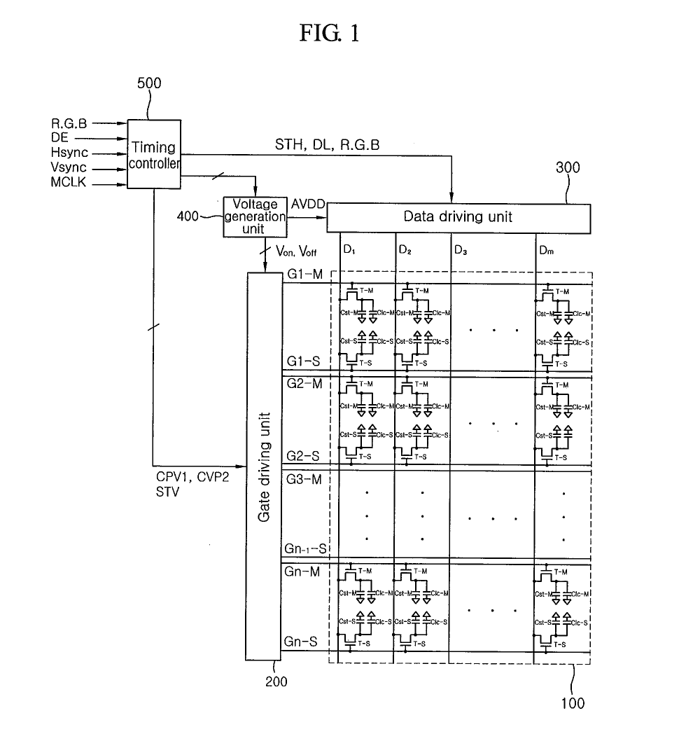

Referring to FIGS. 1 to 3, the display device according to this exemplary embodiment comprises a liquid crystal display (LCD) panel 100, a gate driving unit 200, a data driving unit 300, a voltage generation unit 400, and a timing controller 500.

The LCD panel 100 comprises a plurality of gate lines G1-M to Gn-M and G1-S to Gn-S; a plurality of data lines D1 to Dm intersecting the plurality of gate lines; and a plurality of unit pixels provided at intersection regions of the plurality of gate and data lines. The unit pixel in this exemplary embodiment comprises a main pixel and a sub-pixel. Further, differential voltages are applied respectively to the main pixel and the sub-pixel so as to improve gray inversion, thereby enhancing side visibility and the expressing of natural colors.

The main pixel comprises a main thin film transistor T-M, a main pixel capacitor Clc-M and a main storage capacitor Cst-M, and the sub-pixel comprises a sub thin film transistor T-S, a sub-pixel capacitor Clc-S and a sub-storage capacitor Cst-S. Each of the main-and sub-pixel capacitors Clc-M and Clc-S comprises pixel and common electrodes (not shown), and liquid crystals (not shown) interposed between the pixel and common electrodes serve as dielectrics. The main storage capacitor Cst-M and the sub-storage capacitor Cst-S are formed in such a manner that a storage electrode (not shown) and the pixel electrode overlap with each other. The plurality of gate lines G1-M to Gn-M and G1-S to Gn-S in this exemplary embodiment comprises main-gate lines G1-M to Gn-M and sub-gate lines G1-S to Gn-S.

Gate, source and drain terminals of the main thin film transistor T-M of the aforementioned main pixel are connected to the main gate line G1-M to Gn-M, the data line D1 to Dm, and the pixel electrode of the main pixel capacitor Clc-M, respectively. Such a main thin film transistor T-M operates according to a gate turn-on voltage applied to the main-gate line G1-M to Gn-M and supplies a data signal from the data line D1 to Dm to the pixel electrode of the main pixel capacitor Clc-M. Gate, source and drain terminals of the sub thin film transistor T-S of the sub-pixel are connected to the sub-gate line G1-S to Gn-S, the data line D1 to Dm, and the pixel electrode of the sub-pixel capacitor Clc-S, respectively. Accordingly, the sub thin film transistor T-S operates according to a gate turn-on voltage applied to the sub-gate line G1-S to Gn-S and supplies a data signal from the data line D1 to Dm to the pixel electrode of the sub-pixel capacitor Clc-S.

A plurality of cut-out patterns, which serve as a domain regulating means for regulating the arrangement direction of the liquid crystals, are formed on the pixel electrodes and the common electrode. Instead of the cut-out pattern, a protrusion pattern may be included as the domain regulating means. Preferably, the liquid crystals in this exemplary embodiment are vertically aligned.

It is preferred that each unit pixel comprising the main pixel and the sub-pixel in this exemplary embodiment uniquely display one of the three primary colors (red, green and blue). To this end, a color filter is provided at each of the unit pixels. Further, a black matrix for preventing light leakage is provided between respective unit pixel regions.

Through a peripheral circuit unit comprising a gate driving unit 200, a data driving unit 300, a voltage generation unit 400 and a timing controller 500 is provided outside the LCD panel 100 receives signals for operating the LCD panel.

The gate driving unit 200 and/or the data driving unit 300 may be mounted on a lower display plate of the LCD panel 100. Alternatively, the gate driving unit 200 and/or the data driving unit 300 may be mounted on an additional printed circuit board (PCB) and then electrically connected to the LCD panel 100 through a flexible printed circuit board (FPC). Preferably, the gate and data driving units 200 and 300 in this exemplary embodiment are manufactured in the form of at least one driving chip and then mounted. Preferably, the voltage generation unit 400 and the timing controller 500 are mounted on a PCB and electrically connected to the LCD panel 100 through a FPC.

The timing controller 500 receives input image signals, i.e., pixel data (R, G and B), and input control signals, supplied from an external graphic controller (not shown). At this time, the input control signals include a vertical synchronization signal (Vsync), a horizontal synchronization signal (Hsync), a main clock (MCLK), a data enable signal (DE) and the like. The timing controller 500 generates control signals for controlling operations of the gate driving unit 200, the data driving unit 300 and the voltage generation unit 400 on the basis of the aforementioned pixel data (R, G and B) and input control signals. That is, the timing controller 500 generates a horizontal synchronization start signal (STH) and a data latch signal (DL) for controlling the operation of the data driving unit 300 and supplies the signals to the data driving unit 300. Further, the timing controller 500 generates first and second clock signals CPV1 and CPV2 and a vertical synchronization start signal STV for controlling the operation of the gate driving unit 200 and supplies the signals to the gate driving unit 200. Control signals for controlling the operation of the voltage generation unit 400 include a main clock signal MCLK and a reverse signal.

The voltage generation unit 400 generates various driving voltages required in driving an LCD using external power input from an external power source. That is, the voltage generation unit 400 generates a reference voltage AVDD and applies the reference voltage to the data driving unit 300, and generates a gate turn-on voltage Von and a gate turn-off voltage Voff and applies the voltages to the gate driving unit 200. Further, the voltage generation unit 400 generates a common voltage and applies the common voltage to the main and sub-pixel capacitors Clc-M and Clc-S and the main and sub-storage capacitors Cst-M and Cst-S of the LCD panel 100.

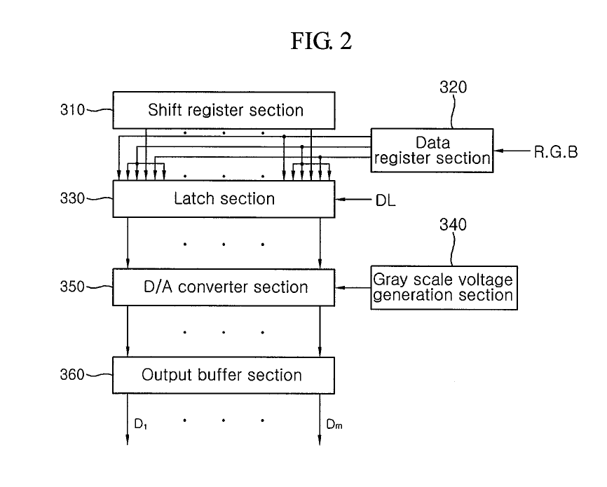

The data driving unit 300 converts input pixel data (R, G and B) in a digital form into data signals DS (DS1, DS2, DS3 and DS4) in an analog form on the basis of the reference voltage AVDD. Further, the data driving unit 300 outputs the data signals DS (DS1, DS2, DS3 and DS4) to the plurality data lines D1 to Dm of the LCD panel 100 in accordance with a data latch signal DL. As shown in FIG. 2, the data driving unit 300 in this exemplary embodiment comprises a shift register section 310, a data register section 320, a latch section 330, a gray scale voltage generation section 340, a digital-to-analog converter (DAC) section 350 and an output buffer section 360.

The shift register section 310 generates a sampling signal on the basis of a control signal supplied from the timing controller 500 and supplies the sampling signal to the latch section 330. The data register section 320 temporarily stores pixel data (R, G and B) sequentially input from the timing controller 500. The latch section 330 samples and latches pixel data (R, G and B), which are temporarily stored in the data register section 320, in correspondence with sampling signals from the shift register section 310. At this time, the latch section 330 simultaneously latches pixel data (R, G and B) corresponding to the respective data lines D1 to Dm in accordance with a data latch signal DL and outputs the pixel data to the D/A converter section 350.

The gray scale voltage generation section 340 has a fixed distribution resistor, and distributes and outputs the reference voltage AVDD as gray scale voltages corresponding to the number of gray scale levels through the distribution resistor. The D/A converter section 350 converts pixel data output from the latch section 330 into data signals DS in an analog form on the basis of the gray scale voltages and then outputs the data signals DS to the output buffer 360. The output buffer section 360 amplifies the data signals in an analog form and outputs the amplified data signals to the plurality of data lines D1 to Dm.

Although the gray scale voltage generation section 340 has been described as being provided in the data driving unit 300 in the aforementioned exemplary embodiment, it is not limited thereto. The gray scale voltage generation section 340 may be provided as a separate module outside the data driving unit 300.

The gate driving unit 200 operates according to the vertical synchronization start signal STV, and applies the gate turn-on voltage Von and the gate turn-off voltage Voff, which are the outputs of the voltage generation unit 400, to the plurality of main and sub-gate lines G1-M to Gn-M and G1-S to Gn-S in accordance with first and second gate clock signals CPV1 and CPV2. First, the gate turn-on voltage Von is applied to the main gate lines G1-M to Gn-M though the first gate clock signal CPV1 so as to turn on the plurality of main thin film transistors T-M connected thereto. Thus, data signals DS1 and DS3 at a first voltage level are provided to the main pixel capacitors Clc-M. Thereafter, the gate turn-on voltage Von is applied to the sub-gate lines G1-S to Gn-S though the second gate clock signal CPV2 so as to turn on the plurality of sub thin film transistors T-S connected thereto. Thus, data signals DS2 and DS4 at a second voltage level are provided to the sub-pixel capacitors Clc-S.

In this exemplary embodiment, the gate turn-on voltage Von is applied to the main and sub-gate lines G1-M to Gn-M and G1-S to Gn-S during logic high intervals of the first and second clock signals CPV1 and CPV2.

If the main thin film transistor T-M is turned on at the same time that the data signals DS1 and DS3 at the first voltage level are applied, there is a problem in that the gate turn-off voltage Voff abnormally rises due to the formation of coupling between the gate and data lines G1-M to Gn-M and D1 to Dm as described in the Discussion of the Background. That is, the voltage level of the gate turn-off voltage Voff rises higher than that of the basic specification set for the operation of the LCD panel 100 in the initial period when the data signals DS1 and DS3 at the first voltage level are applied to the data lines D1 to Dm. Therefore, there may be a problem in that the gate driving unit 200 operates ab normally. Thus, if the main thin film transistor T-M is turned on in an interval in which the gate turn-off voltage Voff abnormally rises the main thin film transistor T-M becomes unstable resulting in the appearance of moving horizontal streaks. g. Accordingly, in this exemplary embodiment, the time when the main thin film transistor T-M is turned on is preferably set to be earlier than the time when the data signals DS1 and DS3 at the first voltage level are applied in this exemplary embodiment. In this way, thin film transistors T-M on one gate line G1-M to Gn-M are turned on in a state where the gate turn-off voltage Voff is stabilized, thereby solving the problem of the unstable operation of the thin film transistors T-M.

The time when the main thin film transistor T-M is turned on is controlled according to the first gate clock signal CPV1, and the time when the data signals DS1 and DS3 at the first voltage level are applied is controlled according to the latch signal DL. Therefore, it is preferred in this exemplary embodiment that the timing of the first gate clock signal CPV1 be changed such that a rising edge interval of the first gate clock signal CPV1 is positioned prior to that of the data latch signal DL. Further, the timing of the second gate clock signal CPV2 is changed due to the change in the timing of the first gate clock signal CPV1. That is, the timing of the second gate clock signal CPV2 is controlled such that a falling edge of the second gate clock signal CPV2 is positioned within the rising edge interval of the first gate clock signal CPV1. It will be apparent that the falling edge of the second gate clock signal CPV2 may be positioned before the rising edge interval of the first gate clock signal CPV1.

As such, it is preferred in this exemplary embodiment that the timing of the timing controller 500 for generating the first and second clock signals CPV1 and CPV2 be controlled to change the timing of the first and second gate clock signals CPV1 and CPV2. To this end, information on changes in the timing of the first and second gate clock signals CPV1 and CPV2 is stored in an additional memory device (e.g., EEPROM). Further, it is preferred that the timing of first and second clock signals CPV1 and CPV2 be changed by allowing the timing controller 500 to read the information on timing changes, which is stored in the memory device, through I²C communication. Furthermore, an additional circuit for changing the timing of the first and second clock signals CPV1 and CPV2 may be added.

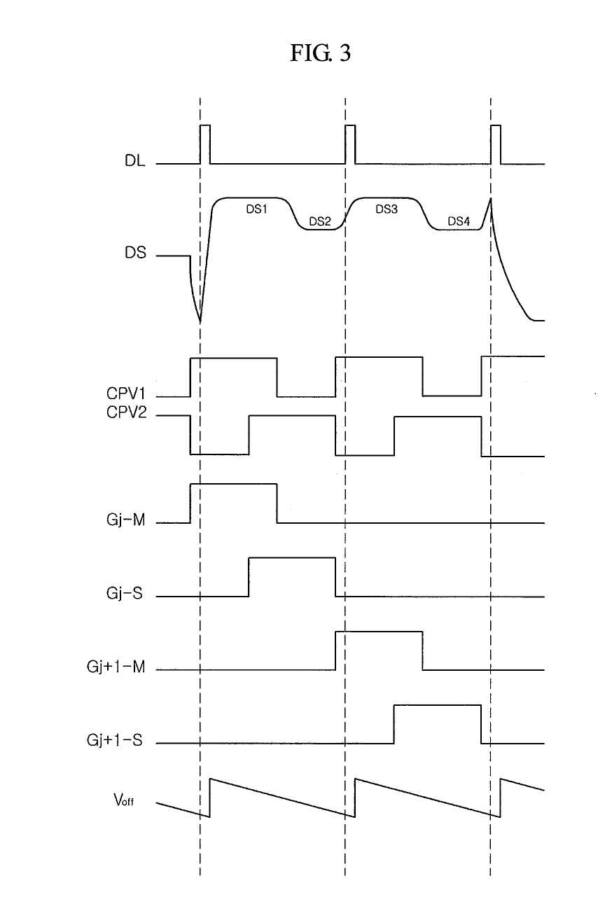

Hereinafter, the operation of the display device of this exemplary embodiment will be described with reference to the waveform diagram of FIG. 3.

In the display device of this exemplary embodiment, the gate driving unit 200 operates according to the control signals from the timing controller 500 and sequentially applies the gate turn-on voltage to the plurality of main and sub-gate lines G1-M to Gn-M and G1-S to Gn-S, so that the main and sub thin film transistors T-M and T-S are sequentially turned on. Further, the data driving unit 300 operates according to the control signals from the timing controller 500 and supplies the data signals DS1, DS2, DS3 and DS4 at the first and second voltage levels to the plurality of data lines D1 to Dm. Accordingly, the data signals DS1 and DS3 at the first voltage level are charged into the main pixel capacitor Clc-M through the turned-on main thin film transistor T-M, and the data signals DS2 and DS4 at the second voltage level are charged into the sub-pixel capacitor Clc-S through the turned-on sub thin film transistor T-S, so that an image is displayed on the unit pixel of the LCD panel 100.

Here, the gate turn-on voltage Von is applied to the main gate lines G1-M to Gn-M in a logic high interval of the first gate clock signal CPV1 so as to turn on the main thin film transistor T-M, and the gate turn-on voltage Von is applied to the sub-gate lines G1-S to Gn-S in a logic high interval of the second gate clock signal CPV2 so as to turn on the sub thin film transistor T-S.

In this exemplary embodiment, as shown in FIG. 3, the first gate clock signal CPV1 is first changed from logic low to logic high, and the gate driving unit 200 applies the gate turn-on voltage Von to a j-th main gate line Gj-M in accordance with the first gate clock signal CPV1 of the logic high so as to turn on a main thin film transistor T-M connected to the j-th main gate line Gj-M. Thereafter, the data driving unit 300 applies the data latch signal DL at logic high so that the data signal DS1 at the first voltage level is applied to the plurality of data lines D1 to Dm. Preferably, the data latch signal DL is supplied in the form of a pulse with a short logic high interval. Accordingly, the data signal DS1 at the first voltage level is supplied to the main pixel capacitor Clc-M through the turned-on main thin film transistor T-M. In this exemplary embodiment, the first gate clock signal CPV1 at logic high is first applied and the data latch signal DL is then applied, so that the main thin film transistor T-M can be turned on in a region where the gate turn-off voltage is stabilized as shown in FIG. 3. Here, assuming that a logic high interval of the first gate clock signal CPV1 is set to 1, it is preferred that the logic high interval of the first gate clock signal CPV1 be applied in advance by about 0.01 to 0.3 before the data latch signal DL.

It will be apparent that since the first gate clock signal CPV1 at logic high is applied prior to the data latch signal DL, a data signal of at second voltage level in a preceding stage may be applied to the main pixel capacitor Clc-M in this exemplary embodiment. However, since the main thin film transistor T-M is continuously turned on during the logic high interval of the first gate clock signal CPV1, the data signal at the second voltage level in the preceding stage is applied and the data signal DS1 at the first voltage level is then applied consecutively. Therefore, it is possible to supply a desired data signal DS1 at the first voltage level to the main pixel capacitor Clc-M.

The gate clock signal CPV2 is changed from logic low to logic high during the supply of the data signal DS1 at the first voltage level. Accordingly, the gate driving unit 200 applies the gate turn-on voltage Von to the j-th sub-gate line Gj-S in accordance with the second gate clock signal CPV2 at logic high so as to turn on the sub thin film transistor T-S connected to the j-th sub-gate line Gj-S. Thereafter, the first gate clock signal CPV1 is changed from logic high to logic low, and the gate driving unit 200 applies the gate turn-off voltage Voff to the j-th main-gate line Gj-M in accordance with the first gate clock signal CPV1 at logic low. Accordingly, the plurality of main thin film transistors T-M connected to the j-th main-gate line Gj-M are turned off. At this time, the data driving unit 300 applies the data signal DS2 at the second voltage level to the plurality of data lines D1 to Dm. Accordingly, the data signal DS2 at the second voltage level is supplied to the sub-pixel capacitor Clc-S through the turned-on sub thin film transistor T-S. In this exemplary embodiment, the voltage at the first voltage level is preferably higher than the voltage at the second voltage level. Accordingly, the data signal DS1 at the first voltage level can be supplied to the main pixel capacitor Clc-M of the unit pixel, and the data signal DS2 at the second voltage level can be supplied to the sub-pixel capacitor Clc-S thereof.

Next, the first gate clock signal CPV1 is again changed into logic high, and the gate turn-on voltage Von is applied to a (j+1)-th main gate line Gj+1-M during a logic high interval of the first gate clock signal CPV1. The plurality of main thin film transistors T-M connected to the (j+1)-th main gate line Gj+1-M are turned on. At this time, since the second gate clock signal CPV2 is changed into logic low, the gate turn-off voltage Voff is applied to the j-th sub-gate line Gj-S, and the plurality of sub thin film transistors T-S connected to the j-th sub-gate line Gj-S are turned off.

Since a data latch signal has not been applied, the data signal DS2 at the second voltage level is continuously supplied to the plurality of data lines D1 to Dm. If the second clock signal CPV2 is changed into logic low during the application of the data signal DS2 at the second voltage level so that the plurality of sub thin film transistors T-S connected to the j-th sub-gate line Gj-S are turned off, it is likely that charging time for the sub-pixel capacitor Cls-S becomes insufficient. However, as described above, the logic high intervals of the first and second clock signals CPV1 and CPV2 overlap with each other in this exemplary embodiment. Accordingly, the data signals DS1 and DS3 at the first voltage level are first applied to the sub-pixel capacitor Clc-S so that the sub-pixel capacitor can be pre-charged, and the data signals DS2 and DS4 at the second voltage level are then applied to the sub-pixel capacitor Clc-S, so that a problem due to the insufficient charging time (i.e., a low charging rate) can be solved. Further, since a data latch signal DL has not been applied, the data signal DS2 at the second voltage level is applied to the main thin film transistors T-M connected to the (j+1)-th main gate line GJ+1-M, so that the main pixel capacitor Clc-M can be pre-charged with the data signal DS2 at the second voltage level.

Thereafter, the data latch signal DL is applied so that the data signal DS3 at the first voltage level is supplied to the plurality of data lines D1 to Dm. Accordingly, the data signal DS3 at the first voltage level is applied to the main pixel capacitor Clc-M through the turned-on main thin film transistor T-M.

Next, the second gate clock signal CPV2 is changed from logic low to logic high so that the gate turn-on voltage Von are applied to a (j+1)-th sub-gate line Gj+1-S. Thus, the plurality of sub thin film transistors T-S connected to the (j+1)-th sub-gate line Gj+1-S are turned on. Thereafter, the first gate clock signal CPV1 is changed from logic high to logic-low, and the data signal DS4 at the second voltage level is supplied to the plurality of data lines D1 to Dm. Accordingly, the data signal DS4 at the second voltage level is supplied to the sub-pixel capacitor Clc-S through the turned-on sub thin film transistor T-S.

As described above, in this exemplary embodiment, the main thin film transistor T-M is turned on before the data latch signal DL is applied, and the sub thin film transistor T-S is turned on after the data latch signal DL is applied, so that the thin film transistors T-M and T-S can be turned on while avoiding an abnormal rising interval of the gate turn-off voltage Voff. Further, turn-on intervals of the main and sub thin film transistors T-M and T-S are caused to overlap with each other, thereby preventing a charging rate of the sub-pixel capacitor Clc-S connected to the sub thin film transistor T-S from being lowered.

In addition, the present invention is not limited to the above descriptions but may be applied to various LCD panel structures. That is, the unit pixel may comprise one TFT, one liquid crystal capacitor and one storage capacitor. Hereinafter, a method for driving an LCD according to a second exemplary embodiment of the present invention will be described. In the following description, descriptions of details overlapping with those of the previous exemplary embodiment will be omitted. The following description can also be applied to the previous exemplary embodiment.

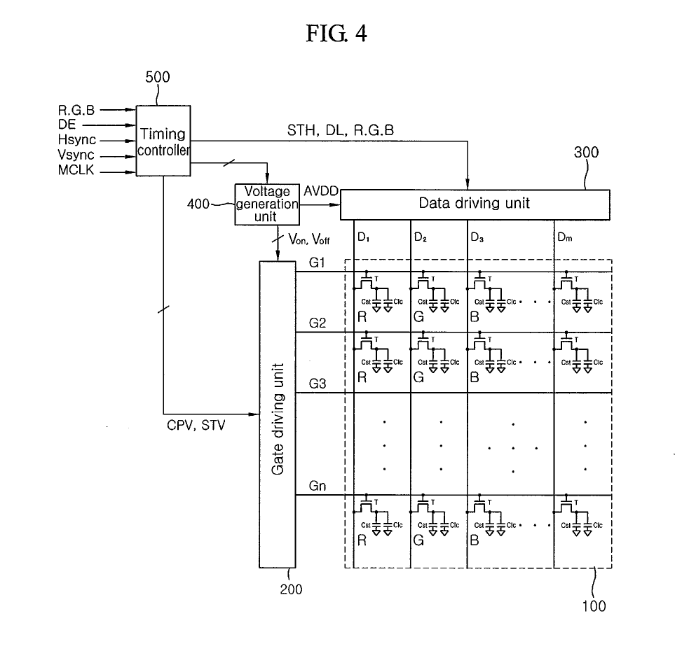

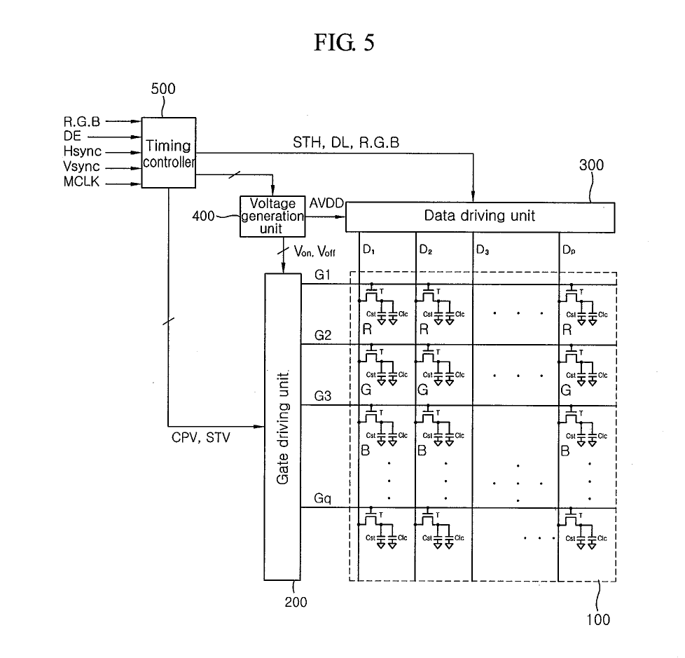

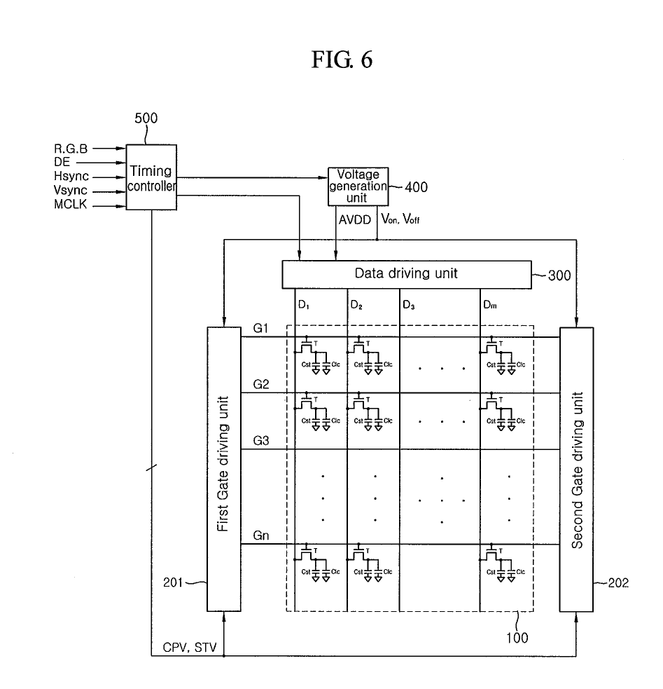

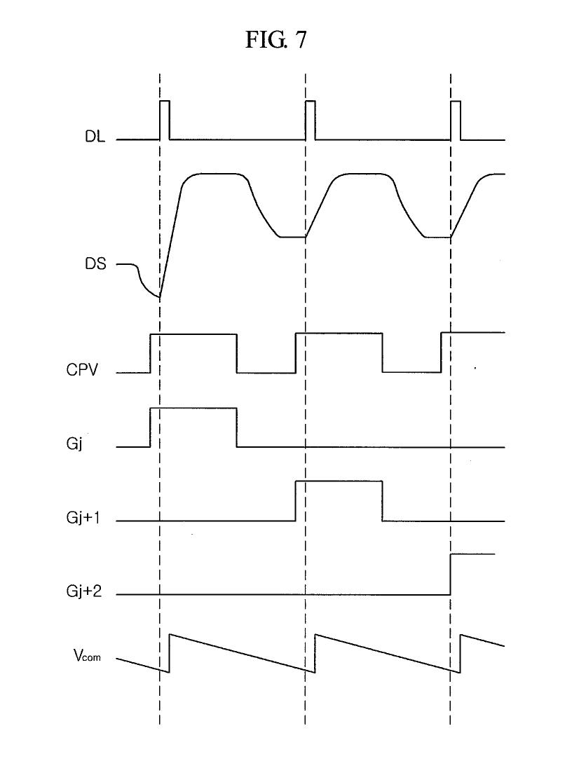

FIG. 4 is a block diagram showing a display device according to a second exemplary embodiment of the present invention, FIGS. 5 and 6 are block diagrams of display devices according to variants of the second exemplary embodiment of the present invention, and FIG. 7 is a waveform diagram illustrating an operation of the display device according to the second exemplary embodiment of the present invention.

Referring to FIGS. 4 to 7, the display device according to this exemplary embodiment comprises an LCD panel 100, a gate driving unit 200, a data driving unit 300, a voltage generation unit 400 and a timing controller 500.

The LCD panel 100 comprises a plurality of gate lines G1 to Gn arranged in rows; a plurality of data lines D1 to Dm arranged in columns perpendicular to the plurality of gate lines; and pixel regions defined by intersection regions of the gate and data lines G1 to Gn and D1 to Dm. A pixel comprising a thin film transistor T, a storage capacitor Cst and a pixel capacitor Clc is provided in the pixel region.

Here, the plurality of gate and data lines G1 to Gn and D1 to Dm and pixel electrodes of the pixel capacitors Clc are formed on a lower substrate. Further, common electrodes and color filters of the pixel capacitors Clc are formed on an upper substrate. Furthermore, a liquid crystal layer is interposed between the upper and lower substrates.

Here, the thin film transistors T are turned on in accordance with a gate turn-on voltage Von supplied from the plurality of gate lines G1 to Gn and then supply data signals DS supplied from the data lines D1 to Dm to the pixel electrodes of the pixel capacitors Clc. At this time, a common voltage is supplied to the common electrodes.

In this exemplary embodiment, three unit pixels operated through one gate line G1 and three data lines D1, D2 and D3 represent one color. Preferably, color filters with different colors are consecutively arranged in the unit pixels disposed adjacent to one another in a horizontal direction, and color filters with the same color are consecutively arranged in the unit pixels disposed adjacent to one another in a vertical direction. Further, it is preferred that the length of the unit pixel in the vertical direction be longer than that of the unit pixel in the horizontal direction.

Of course, the LCD panel 100 in this exemplary embodiment is not limited thereto but may be modified variously. For example, three unit pixels operated through three gate lines G1, G2 and G3 and one data line D1 may represent one color as shown in FIG. 5. Preferably, color filters with different colors are consecutively arranged in the unit pixels disposed adjacent to one another in the vertical direction, and color filters with the same color are consecutively arranged in the unit pixels disposed adjacent to one another in the horizontal direction. That is, red, green and blue color filters are sequentially provided in the unit pixels disposed adjacent to one another in the vertical direction as shown in FIG. 5. To represent one color through such a variant, the number of data lines D1 to Dp can be decreased to ⅓ times, whereas the number of gate lines G1 to Gq is increased three times as compared with the prior art. It is preferred that the length of each of the plurality of unit pixels in the horizontal direction be longer than that of each of the plurality of unit pixels in the vertical direction. Accordingly, it is possible to prevent the length of the LCD panel 100 from being increased in the vertical direction.

The data driving unit 300 in this exemplary embodiment converts pixel data (R, G and B) in a digital form, which are supplied from the timing controller 500, into data signals DS in an analog form on the basis of a reference voltage AVDD of the voltage generation unit 400, and outputs the data signals DS to the data lines D1 to Dm of the LCD panel 100 in accordance with a data latch signal DL. Here, the data signals DS may be reversed and then supplied to the data lines D1 to Dm, if necessary.

The gate driving-unit 200 applies gate turn-on and turn-off voltages Von and Voff, which are outputs of the voltage generation unit 400, to the plurality of gate lines G1 to Gn in accordance with a gate clock signal CPV from the timing controller 500. Accordingly, the plurality of thin film transistors T connected to the gate lines G1 to Gn to which the gate turn-on voltage Von is applied are turned on so that the data signals DS are supplied from the data lines D1 to Dm to the pixel capacitors Clc. In this exemplary embodiment, the gate turn-on voltage Von is applied to the gate lines G1 to Gn before the data signals DS are applied to the data lines D1 to Dm, so that the plurality of thin film transistors T connected to the gate lines G1 to Gn are first turned on. To this end, the gate clock signal CPV is applied before the data latch signal DL is applied.

The gate driving unit 200 may be provided in an IC form at one peripheral region of the LCD panel 100. Here, the gate driving unit 200 is not limited thereto but may be modified variously. That is, first and second driving units 201 and 202 may be disposed at both peripheral regions of the LCD panel 100 as shown in FIG. 6, respectively.

Accordingly, gate turn-on and turn-off voltages Von and Voff may be applied at both sides of the plurality of gate lines G1 and Gn. The first and second driving units 201 and 202 receive the gate clock signal CPV and supply the gate turn-on and turn-off voltages Von and Voff of the voltage generation unit 400 to the plurality of gate lines G1 and Gn, respectively.

The operation of the display device of this exemplary embodiment will now be described with reference to the waveform diagram of FIG. 7. As shown in FIG. 7, the gate clock signal is changed from logic low to logic high. The gate driving unit 200 applies the gate turn-on voltage Von to a j-th gate line Gj during a logic high interval of the gate clock signal CPV. Accordingly, a plurality of thin film transistors T connected to the j-th gate line Gj are turned on. Thereafter, the data latch signal DL is applied so that the data signal DS is applied to the plurality of data lines DL. Thus, the data signal DS is supplied to the pixel through the plurality of turned-on thin film transistors T.

In this exemplary embodiment, the gate clock signal CPV is first applied to turn on the thin film transistors, and the data latch signal DL is then applied so that the data signal DS can be applied. Accordingly, the thin film transistors T can be turned on in a state where the gate turn-off voltage Voff is stabilized. Further, the method for driving the display device according to the present invention can be applied to various LCDs. That is, the gate driving unit may be manufactured in a stage form on a substrate with TFTs formed thereon.

Hereinafter, a method for driving an LCD according to a third exemplary embodiment of the present invention will be described.

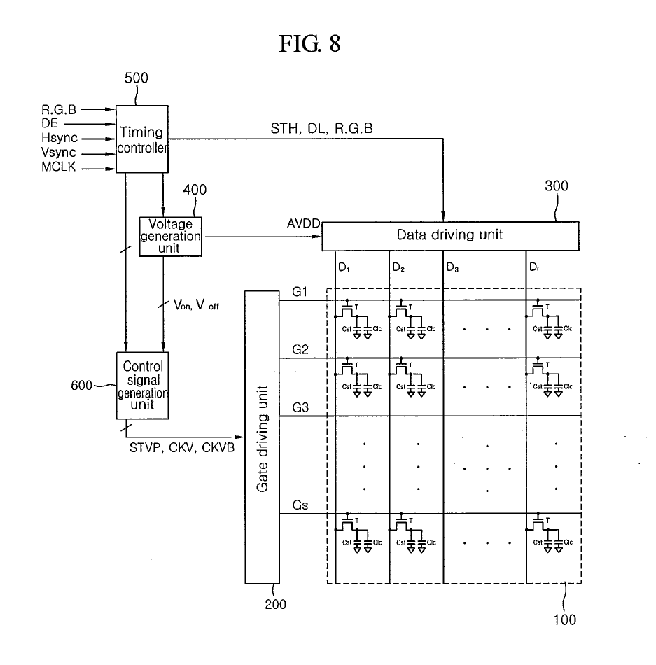

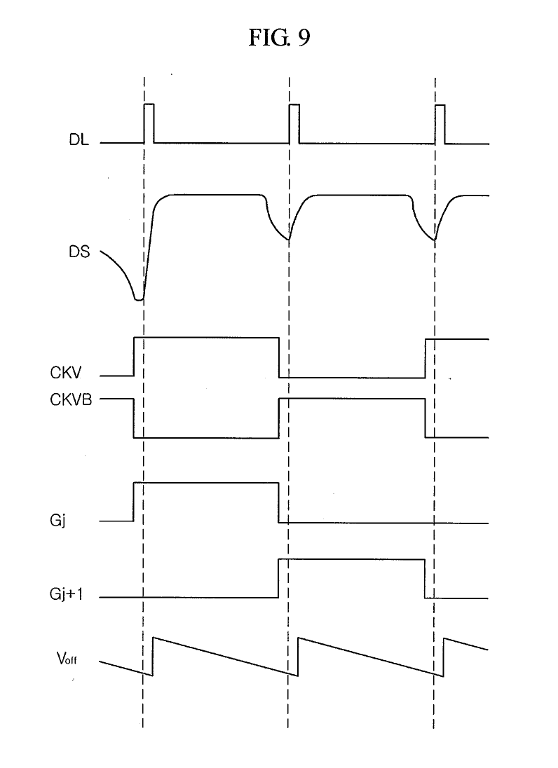

In the following description, descriptions of details overlapping with those of the previous exemplary embodiments will be omitted. The following description can also be applied to the previous exemplary embodiments. FIG. 8 is a block diagram showing a display device according to a third exemplary embodiment of the present invention. FIG. 9 is a waveform diagram illustrating an operation of the display device according to the third exemplary embodiment of the present invention.

Referring to FIGS. 8 and 9, the display device according to this exemplary embodiment comprises an LCD panel 100, a gate driving unit 200, a data driving unit 300, a voltage generation unit 400, a timing controller 500 and a control signal generation unit 600.

Display and peripheral regions are defined in the LCD panel 100. The display region is provided with a plurality of gate and data lines G1 to Gs and D1 to Dr, thin film transistors T, pixel capacitors Clc and storage capacitors Cst.

The gate driving unit 200 comprises a plurality of stage sections (not shown) respectively connected to the plurality of gate lines G1 to Gs. Further, the gate driving unit 200 is-formed at the peripheral region of the LCD panel 100. The gate driving unit 200 in this exemplary embodiment supplies gate turn-on and turn-off voltages Von and Voff to the plurality of gate lines G1 to Gs of the LCD panel 100 in accordance with a clock signal CKV, a reversed clock signal CKVB and a start signal STVP from the control signal generation unit 600. At this time, the control signal generation unit 600 in this exemplary embodiment receives a vertical synchronization start signal STV and a gate clock signal CPV supplied from the timing controller 500 and a voltage supplied from the voltage generation unit 400, and generates a clock signal CKV, a reversed clock signal CKVB and a start signal STVP.

Hereinafter, the operation of the display device according to this exemplary embodiment will be described with reference to FIG. 9. In this exemplary embodiment, the clock signal CKV is first changed from logic low to logic high, and the reversed clock signal CKVB is simultaneously changed from logic high to logic low. At this time, the gate driving unit 200 supplies the gate turn-on voltage Von to a j-th gate line Gj in accordance with the clock signal CKV at logic high. Accordingly, a plurality of thin film transistors T connected to the j-th gate line Gj are turned on. Thereafter, the data latch signal DL is applied to supply the data signal Ds to the plurality of data lines D1 to Dm. Thus, the data signal DS is supplied to the pixel capacitors Clc through the plurality of thin film transistors T. At this time, in this exemplary embodiment, the time when the clock signal CKV is changed into logic high is set to be earlier than the time when the data latch signal DL is applied. Accordingly, the thin film transistors T can be turned on by avoiding an interval in which the gate turn-off voltage Voff abnormally rises.

Next, the clock signal CKV is changed from logic high to logic low, and the reversed clock signal CKVB is simultaneously changed from logic low to logic high. At this time, the gate driving unit 200 supplies the gate turn-on voltage Von to a (j+1)-th gate line Gj+1 in accordance with the reversed clock signal CKVB with logic high. Accordingly, a plurality of thin film transistors T connected to the (j+1)-th gate line Gj+1 are turned on. Thereafter, the data latch signal DL is applied to supply the data signal DS is supplied to the plurality of the data lines D1 to Dm. Thus, the data signal DS is supplied to the pixel capacitors Clc through the plurality of turned-on thin film transistors T.

As described above, according to the present invention, thin film transistors are first turned on before a data signal is applied, so that unstable operations of the thin film transistors can be prevented. Further, according to the present invention, generation of gate noise can be prevented by applying a gate-turn-on voltage before a data latch signal to turn on thin film transistors prior to an interval in which a gate turn-off voltage abnormally rises.

Furthermore, according to the present invention, it is possible to prevent generation of horizontal streaks at a lower portion of a screen by preventing generation of gate noise.

Although the present invention has been described in connection with the preferred exemplary embodiments and the drawings it will be apparent to those skilled in the art that various changes and modifications can be made thereto without departing from the technical spirit and scope of the invention.

What is claimed is:

1. A method for driving a display device, comprising the steps of:
turning on a plurality of first thin film transistors (TFTs) in accordance with a first clock signal from a timing controller;
supplying a data signal at a first voltage level to first pixel capacitors through the turned-on first TFTs in accordance with a data latch signal from the timing controller;
turning on a plurality of second TFTs in accordance with a second clock signal from the timing controller;
turning off the plurality of first TFTs and supplying a data signal at a second voltage level to second pixel capacitors through the turned-on second TFTs; and
turning off the plurality of second TFTs.

2. The method as claimed in claim 1, wherein the first and second TFTs are turned on during logic high intervals of the first and second clock signals, and the first gate clock signal at logic high is applied prior to the data latch signal.

3. The method as claimed in claim 1, wherein when the first gate clock signal is changed from logic low to logic high, the second gate clock signal is changed from logic high to logic low.

4. The method as claimed in claim 1, wherein logic high intervals of the first and second clock signals overlap with each other.

5. A display device comprising:
a timing controller for supplying first and second gate clock signals, a data signal and a data latch signal;
a voltage generation unit for supplying a gate turn-on voltage and a gate turn-off voltage;
a liquid crystal display (LCD) panel provided with first and second thin film transistors (TFTs) driven by a voltage applied to first and second gate lines so as to supply first and second pixel capacitors with the data signal applied to data lines;
a gate driving unit for supplying the gate turn-on or turn-off voltage to the first and second gate lines in accordance with the first and second clock signals; and
a data driving unit for supplying the data signal to the data lines in accordance with the data latch signal,
wherein the gate turn-on voltage is applied to the first and second gate lines during logic high intervals of the first and second gate clock signals, and the first gate clock signal at logic high is applied prior to the data latch signal.

6. The display device as claimed in claim 5, wherein the first gate clock signal at logic high is first applied, and the logic high intervals of the first and second gate clock signals overlap with each other.

7. The display device as claimed in claim 5, wherein the LCD panel has a substrate provided with the first and second TFTs, and the gate driving unit is mounted on the substrate in the form of an IC chip connected to at least one side region of the first and second gate lines or manufactured on the substrate in the form of a plurality of stages connected to at least one side region of the first and second gate lines.

8. A method for driving a display device, comprising the steps of:
turning on a plurality of thin film transistors (TFTs) in accordance with a gate clock signal of a timing controller;
supplying a data signal to pixel capacitors through the plurality of turned-on TFTs in accordance with a data latch signal from the timing controller; and
turning off the plurality of TFTs.

9. The method as claimed in claim 8, wherein the TFTs are turned on during a logic high interval of the gate clock signal, and the gate clock signal at logic high is applied prior to the data latch signal.

10. A display device comprising:
a timing controller for supplying a gate clock signal, a data signal and a data latch signal;
a voltage generation unit for supplying a gate turn-on voltage and a gate turn-off voltage;
a liquid crystal display panel provided with thin film transistors driven by a voltage applied to gate lines so as to supply the data signal from data lines to respective pixel capacitors;
a gate driving unit for supplying the gate turn-on or turn-off voltage to the gate lines in accordance with the clock signal; and
a data driving unit for supplying the data signal to the data lines in accordance with the data latch signal,
wherein the gate turn-on voltage is applied to the gate lines during a logic high interval of the gate clock signal, and the gate clock signal at logic high is applied prior to the data latch signal.

11. The display device as claimed in claim 10, further comprising a control signal generation unit provided between the timing controller and the gate driving unit to generate a clock signal or a reversed clock signal in accordance with the gate clock signal and to apply the generated signal to the gate driving unit.
